(19) United States
(12) Patent Application Publication
(10) Pub. No.: US 2007/0186417 A1
(43) Pub. Date: Aug. 16, 2007

(54) Method for electronically identifying a coded part

(76) Inventor: Larry C. Smyth, Annapolis, MD (US)

Correspondence Address: SCHWARTZ LAW FIRM, P.C., 6100 FAIRVIEW ROAD, SUITE 11350, CHARLOTTE, NC, 28210, US

(21) Appl. No.: 10/591,571

(22) PCT Filed: Mar. 3, 2005
(86) PCT No.: PCT/US05/06898

§ 371 Date: Sep. 1, 2006

Related U.S. Application Data
(60) Provisional application No. 60/549,822, filed on Mar. 3, 2004.

(30) Foreign Application Priority Data
Jun. 8, 2004 (US) PCT/US04/18082
Jul. 19, 2004 (US) PCT/US04/23133

(51) Int. Cl. B23P 17/00; B21D 53/26

(52) U.S. Cl. 29/894; 29/894.35; 29/407.01; 29/407.05

(57) ABSTRACT

A method for electronically identifying a coded part includes the step of locating a machine-readable area relief pattern formed with a surface of the part. The relief pattern includes separate and distinct code elements extending along both x and y axes. Each code element has a profile dimension extending along a z-axis relative to a native surface of the part. A region of interest containing the area relief pattern is then measured along the x, y, and z axes. The area relief pattern is then extracted from the measured region of interest. The area relief pattern is then decoded to extract part information encoded in the relief pattern.

### TECHNICAL FIELD AND BACKGROUND OF THE INVENTION

This invention relates generally to a method for electronically identifying coded manufactured parts, and more specifically, to a method for identifying cast alloy wheels on-the-fly during the manufacturing process. The invention further provides a novel, distinct solution for tracking vehicle wheels and other parts through various stages of manufacture.

It is important that certain manufactured parts be traceable back to and through manufacturing. Thus, for example, if a safety critical defect is detected in a particular part, then parts with the same history can be identified and tracked down to minimize damage and liability. As such, it is essential that many parts be permanently marked in such a manner that manufacturing records for the part can be retrieved for analysis at an unknown future date. For example, aluminum wheels are a primary structural component of an automobile that requires full traceability for safety reasons.

Reliable marking and automated scanning into a manufacturing database enables wheel serialization. A particular benefit is that scanning the serial number provides the exact wheel model and prior history, which is often necessary to adjust the upcoming process equipment during manufacture. Currently, this is either done with operating staff or machine vision systems that look at the face of the wheel. For some processes, it is also important that the angular orientation of the wheel is also identified.

The manufacturing of cast alloy wheels is generally an ordered process of sequential events. Some of these events are specific to an exact wheel model, while others are not. For example, machining is geometry specific. If the wrong casting is loaded in an automated machining cell, a dangerous and expensive crash occurs. Heat-treating, on the other hand, is non-specific to the wheel model. However, as heat-treating is approximately a single shift long process, it is still useful to know what is in the furnace for planning the subsequent operations. For reasons as diverse as these, it is advantageous to identify wheels during manufacture by their model number.

The most common method to identify wheels is by a human operator. But in higher volume automated operations, this is both expensive and less than 100% reliable. Consequently, sensor-based wheel model recognition systems are desired. Various sensor technologies are used, the most prevalent being machine vision. Here, a snapshot of the wheel face is taken and compared against stored values. While this is generally straightforward for a human, it is a difficult task for machine vision, primarily because the snapshot is only a 2-D image. Often such systems are only useful when other inputs are used in parallel, or series snapshots are required to eliminate the probability of misidentification.

The need for automated rapid identification of manufactured parts has led to information encoded as 1-D bar codes for machine-reading. These all-pervasive linear barcodes are typically high contrast marks, most often black bars on a white background to facilitate reliable and rapid scanning and decoding. When low contrast barcodes are used they are generally unreliable with conventional scanners. A solution used to overcome the low contrast issue is to use a particular type of 2-D barcode, where the bars are either below or above the general surface. Then, by using more sophisticated scanners, for example, those based on laser distant measurement units, these linear bar codes can be reliably read. This type of 2-D barcode is generally referred to as linear “bumpy barcode.”

For hostile and abrasive environments, the use of bumpy barcode and other 2-D DataMatrix like area barcoding formed by DPM processes is common. While such laser formed area marks are more or less 2-D, peened area marks are actually 3-D marks. Either way, low contrast is often encountered, and such marks can only be scanned satisfactorily when special contrast enhancing lighting and narrow field of views are practiced. Eliminating surface variations in the area carrying the mark and controlling its orientation relative to the scanner are often required to improve automated read rates.

Scanning Background

Direct part marking (DPM) with peened codes presents a visual contrast problem for scanners. Suitable lighting resolves this constraint for many parts; however, round parts such as wheels pose particular difficulties, especially when on-the-fly scanning is required.

In general, it is advisable to have the entire code in the scanner field of view (FOV) for robust decoding. This is particularly true for position-based area and bar codes. Some code variants with a timing mechanism to desensitize positioning can sometimes deviate from this FOV requirement, especially if the coding alignment and orientation are constrained relative to the lighting and scanner. Also, if the scanner resolution and scan rate is high enough relative to any motion irregularities, the code does not necessarily need be in a single FOV.

Peened area codes are in the broadest sense three-dimensional coding that can be detected, for example, by tactile surface scanning. They also can be detected by non-contact surface scanning, such as by optical triangulation or interferometery methods. All such advanced optical systems require specialized illumination of the code. More conventional vision based systems also require controlled lighting to enhance the peen code contrast.

Laser code scanning is used for high contrast printed bar codes, but it is not practiced industrially for peen coding. To be suited for peen marked parts, laser surface mapping is required. Then, by subtracting the background surface, the code can be “seen” for decoding. While other techniques can be used, single point laser distant measurement based on triangulation is the basis of surface mapping where there is a large FOV and DOF requirement, as needed for wheel code scanning on-the-fly. While the single point can be upgraded to a continuous line without raster movement, the complete area code can never be in the FOV. As such, the peen coding must be sufficiently pronounced to prevent relative movement sensor “noise” from losing or adding individual peen marks and locations. Fortunately, this does not appear to be a problem for marking wheel castings for conveying past a fixed-mount scanner, as they have overly large machining stock on the desired rim locations to facilitate castability.

The broad concept of the present invention is to mark a manufactured part, such as a wheel casting, with a machine-readable area relief pattern. In one application, the area relief pattern is a 3-D peened code—although other coded surface profiles are contemplated. The wheel can be scanned on-the-fly to generate a 3-D surface map in a region of interest containing the coded pattern. By extracting the coded pattern from the measured region of interest, a suitable decoder can then extract the part information contained in the code.

### SUMMARY OF THE INVENTION

Therefore, it is an object of the invention to provide a method for electronically identifying a coded part.

It is another object of the invention to provide a method for electronically identifying a coded part on-the-fly during manufacturing.

It is another object of the invention to provide a method for electronically identifying a coded part on-the-fly as speeds in excess of 1 foot per second (fps).

It is another object of the invention to provide a method for electronically identifying a coded part which utilizes precise and accurate means for marking and reading a coded 3-D area relief pattern.

These and other objects of the present invention are achieved in the preferred embodiments disclosed below by providing a method for electronically identifying a coded part. The method includes the steps of locating a machine-readable area relief pattern formed with a surface of the part. The relief pattern comprising separate and distinct code elements extending along both x and y axes. Each code element has a profile dimension extending along a z-axis relative to a native surface of the part. A region of interest containing the area relief pattern is then measured along the x, y, and z axes. The area relief pattern is then extracted from the measured region of interest. The area relief pattern is then decoded to extract part information encoded in the relief pattern.

According to another preferred embodiment of the invention, the step of measuring the region of interest comprises employing a laser line scanner adapted for projecting a laser line onto the surface of the part containing the area relief pattern.

According to another preferred embodiment of the invention, the step of measuring the region of interest further comprises moving the coded part relative to the laser line scanner.

According to another preferred embodiment of the invention, the method includes measuring the region of interest on-the-fly as the coded part is moved past the laser line scanner.

According to another preferred embodiment of the invention, the method includes moving the coded part past the laser line scanner at a minimum rate of 1 fps.

According to another preferred embodiment of the invention, the method includes arranging multiple laser line scanners at predetermined locations relative to the moving coded part.

Preferably, the area relief pattern comprises a peened area code.

According to one embodiment, the coded part comprises a cast alloy wheel.

Preferably, the area relief pattern is formed with a rim barrel of the wheel.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a side view of a vehicle wheel carried on a powered roller conveyor, and including a coded area relief pattern applicable in practicing a method according to one preferred embodiment of the invention;

FIG. 1A is an enlarged view of the coded area relief pattern shown in FIG. 1;

FIG. 2 is a top view of the vehicle wheel on the powered roller conveyor, and surrounded by several fixed-mounted scanners applicable for measuring a surface of the wheel containing the coded area relief pattern;

FIG. 3 is a further enlarged view of the coded area relief pattern;

FIG. 4 is a cross-sectional view taken substantially along line A-A of FIG. 3;

FIG. 5 is a cross-sectional view taken substantially along line B-B of FIG. 3;

FIG. 6 is a schematic view demonstrating operation of the laser line scanner; and

FIG. 7 shows a cross-sectional profile of a portion of the vehicle wheel during operation of the line scanner.

### DESCRIPTION OF THE PREFERRED EMBODIMENT AND BEST MODE

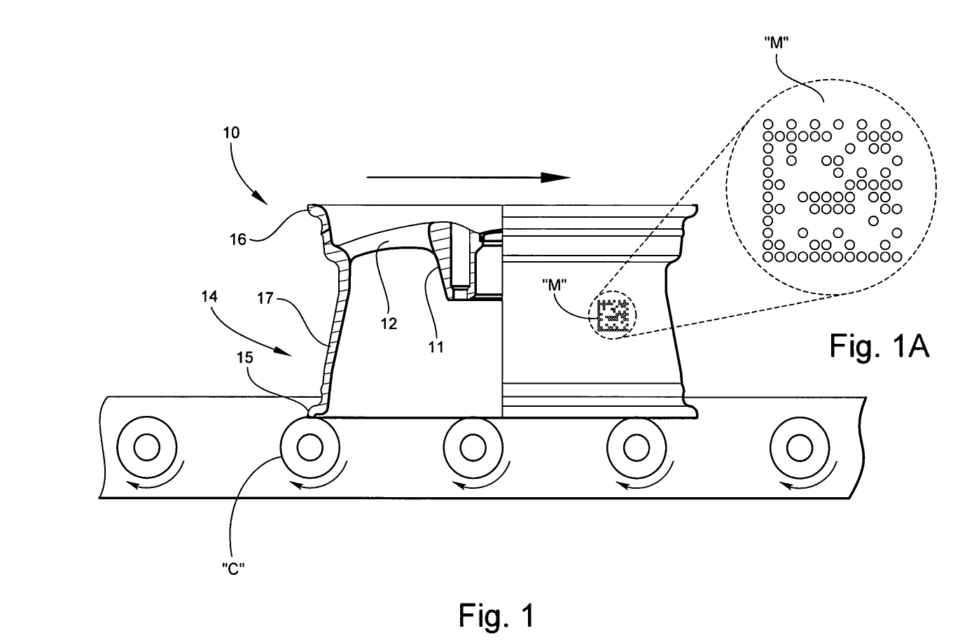

Referring now specifically to the drawings, FIG. 1 illustrates a standard cast aluminum wheel 10 applicable for electronic identification according to a method of the present invention. The vehicle wheel 10 comprises an integrally-formed center hub 11, hub spokes 12, and wheel rim 14. The wheel rim 14 has an annular inboard flange 15, an opposing annular outboard flange 16, and a rim barrel 17. In the embodiment shown, the rim barrel 17 includes one or more machine-readable identification marks “M” containing useful information regarding the vehicle wheel 10. This information may include, for example, the serial number, wheel model, size, mold number, angular orientation, and the like. Other suitable areas for marking include the hub spokes 12 and rim areas 14, 15, and 16.

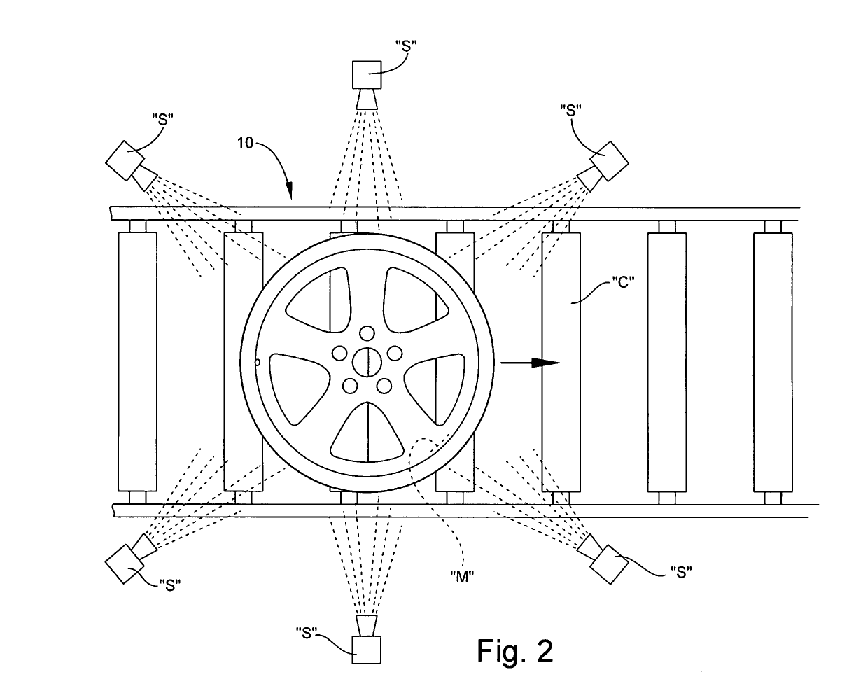

The wheel 10 is generally processed after casting in a face-up position with the inboard flange 15 resting directly on a powered roller conveyor “C”, as best shown in FIG. 2. The conveyor transports the wheel 10 at speeds in excess of 1 fps. The present method includes locating the identification mark “M” on the wheel 10, and electronically reading the mark “M” on-the-fly as the wheel 10 moves downstream from one processing location to the next. Typical wheel processing includes deflashing (fettling), desprueing, fluoroscopic inspection, solution heat-treatment, quenching, aging heat-treatment, shot blasting, painting, machining, clear coating and final inspection.

Standard line of sight tracking systems require the wheel identification mark to be presented within the scanner's field of view. While several non-contact distance reading technologies are suitable, to get high resolution the distance variation of the mark to the scanner (depth of field, or DOF) must be kept within a relatively tight range—usually under 50 mm. The field of view (FOV) of such high-resolution scanners is also relatively limited—in the sub 100 mm range. The DOF and FOV of optical camera vision scanners are significantly less—especially the DOF. The wheel identification mark, which can be any size but is typically in the 10 mm range, is preferably read when perpendicular to and in the same plane as the scanner.

As indicated above, the concept of the present method is to locate and read the wheel identification mark “M” on-the-fly during processing without slowing or stopping downstream forward movement of the vehicle wheel 10. FIG. 2 demonstrates but one preferred application of this concept. In this embodiment, the wheel identification mark “M” is applied to an outer surface of the rim barrel 17. While moving downstream on the roller conveyor “C”, the wheel 10 enters an identification zone comprising a number of fixed-mounted strategically arranged non-contact laser line scanners “S” operable for reading the entire outer circumferential surface area of the wheel 10. The identification mark “M” is located and electronically read by at least one of the scanners “S” regardless of the wheel's orientation on the roller conveyor “C”, and without slowing or stopping the wheel 10. In an alternative embodiment, the wheel may include multiple strategically spaced ID marks—one of which would be in position for reading by a single fixed-mount scanner regardless of the wheel's orientation on the roller conveyor. In a further alternative embodiment, the scanner may be slidably mounted for movement relative to the moving wheel in a manner sufficient to locate and read a single ID mark applied to the wheel.

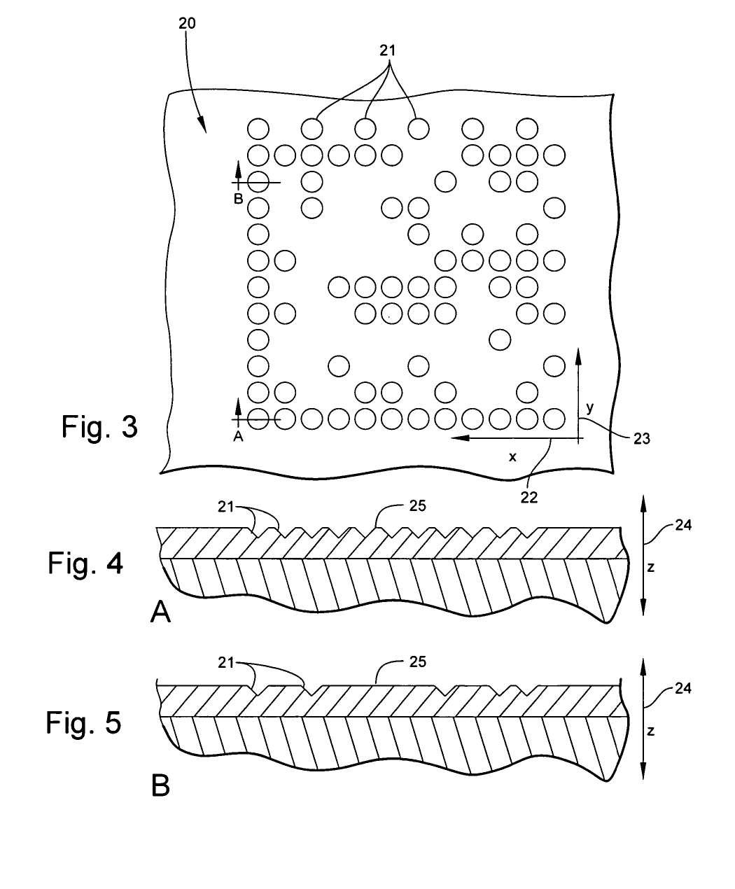

Referring to FIGS. 3, 4, and 5, the wheel identification mark “M” is preferably a machine-readable coded area relief pattern 20 which may be raised, indented, peened, cast, etched, stamped, molded, laser engraved, or embossed directly into a surface of the wheel 10 using any conventional direct part marking (DPM) process. The relief pattern 20 comprises an assembly of separate and distinct code elements 21 extending along both x and y axises indicated at 22 and 23, respectively, and each having a profile dimension (either raised or recessed) extending along a z-axis 24 relative to a native surface 25 of the wheel 10. Unlike traditional two-dimensional area barcode, the present three-dimensional relief pattern 20 is read by using differences in height, rather than contrast. This type of coding is particularly useful where printed labels will not adhere, or would be otherwise destroyed by a hostile or abrasive environment. A similar but distinct concept of linear relief coding, known in the art as “bumpy barcode”, is discussed in U.S. Pat. No. 5,393,967. The complete disclosure of this prior patent is incorporated herein by reference.

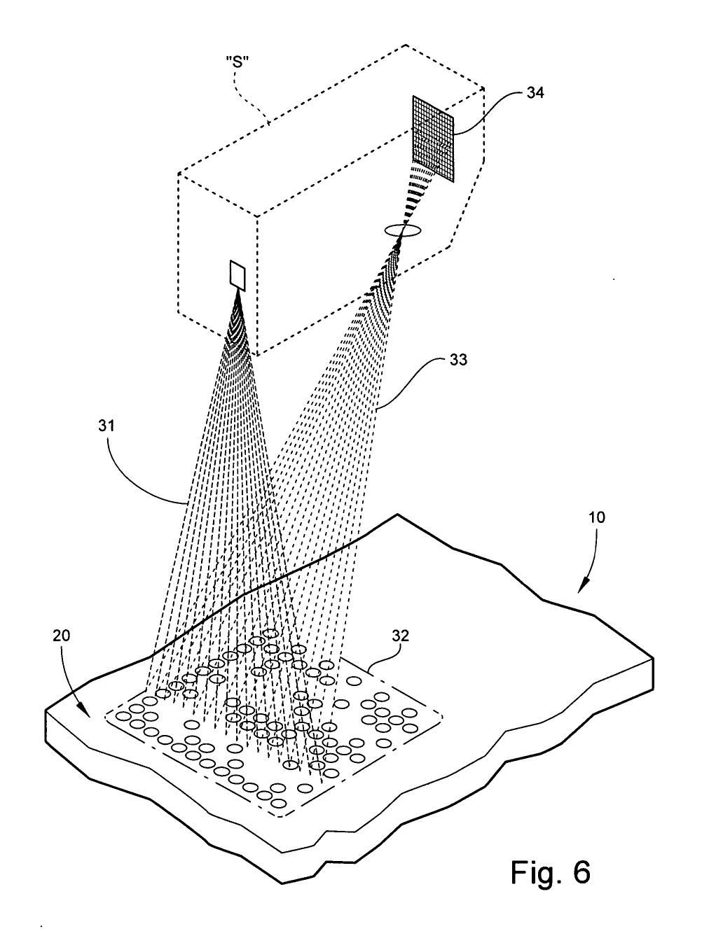

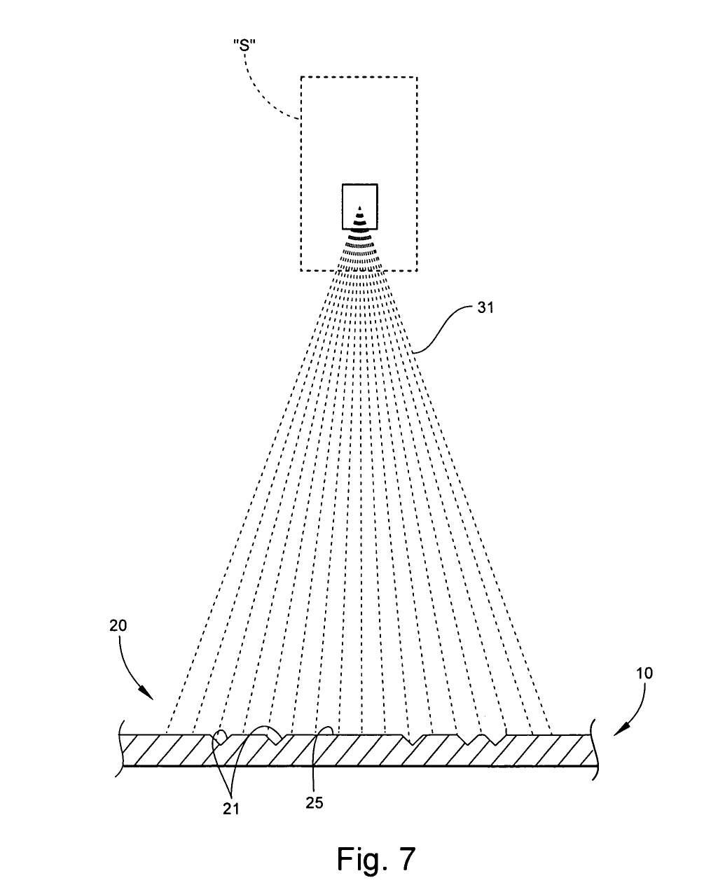

Preferably, the code reader or scanner “S” discussed above comprises a non-contact laser line scanner such as that offered by Micro-Epsilon of Raleigh, N.C. under the name LLT 2800. As demonstrated in FIGS. 6 and 7, the line scanner “S” projects a laser line 31 onto the surface of the vehicle wheel 10 within a notional region of interest 32 containing the coded mark 20. The reflected image 33 is then captured in a two-dimensional CCD 34. The angular displacement between the laser 31 and CCD array 34 allows detection of the differences in height across the area relief pattern 20. Once captured by the CCD array 34, the reflected image 33 is digitized and processed by a conventional onboard digital signal processor.

The resulting output is a data stream that creates a point cloud. This point cloud contains not only the planar data of the measured surface, but also the depth; it also includes various deviation errors. In order to convert this point cloud to a planar surface, a certain data handling approach is required to correct the errors. First, the line data is sorted, both the line point data set and the line to line sets. Then, the cleaned 3-D point cloud is converted to a quadrilateral meshed surface volume, so that precision surface modeling with NURBS, for example, is performed. The next step is to correct for shape deviations, the main influence being the curvature of the cast outer wheel rim surface radii. Once this is finished, a flat equivalent surface map results that contains in one portion the peen-coded region. Next a region of interest (ROI) algorithm is applied so that only the coded surface region is analyzed to limit the final decoding task.

The decoding task involves determining the peen marks and their rough relative positions, and then using defined data matrix layout rules and geometry to reconstruct the peen code on a perfect grid pattern. At this point data matrix algorithms are applied to determine if the code is a decodable matrix, and then to extract the coded information contained in the matrix. This information is then available for further use, such as an alphanumeric display or insertion into data bases.

A more complete and detailed discussion regarding laser point cloud analysis and mathematical manipulation is provided in the article Evaluation and Correction of Laser-Scanned Point Clouds by Christian Teutsch, Tobias Isenberg, Erik Trostmann, Michael Weber, Dirk Berndt, and Thomas Strothotte, and published in Proceeding of Videometrics VIII (Electronic Imaging 2005, Jan. 16-20, 2005, San Jose, Calif., USA), volume 5665 of SPIE Proceedings Series, pages 172-183, Bellingham, Wash., 2005. SPIE/IS&T. The complete disclosure of this article is incorporated herein by this reference.

A method for electronically identifying a coded part is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A method for electronically identifying a coded part, said method comprising the steps of:
(a) locating a machine-readable area relief pattern formed with a surface of the part, the relief pattern comprising separate and distinct code elements extending along both x and y axes, and each having a profile dimension extending along a z-axis;
(b) measuring along the x, y, and z axes a region of interest containing the area relief pattern;
(c) extracting the area relief pattern from the measured region of interest; and
(d) decoding the area relief pattern to extract part information encoded therein.

2. A method according to claim 1, wherein the step of measuring the region of interest comprises employing a laser line scanner adapted for projecting a laser line onto the surface of the part containing the area relief pattern.

3. A method according to claim 2, wherein the step of measuring the region of interest further comprises moving the coded part relative to the laser line scanner.

4. A method according to claim 3, and comprising measuring the region of interest on-the-fly as the coded part is moved past the laser line scanner.

5. A method according to claim 4, and comprising moving the coded part past the laser line scanner at a minimum rate of 1 fps.

6. A method according to claim 5, and comprising arranging multiple laser line scanners at predetermined locations relative to the moving coded part.

7. A method according to claim 1, wherein the area relief pattern comprises a peened area code.

8. A method according to claim 1, wherein the coded part comprises a cast alloy wheel.

9. A method according to claim 8, wherein the area relief pattern is formed with a rim barrel of the wheel.

10. A method for electronically identifying a coded part, said method comprising the steps of:
(a) marking an exposed surface of the part with a machine-readable area relief pattern, the relief pattern comprising separate and distinct code elements extending along both x and y axes, and each having a profile dimension extending along a z-axis;
(b) locating the area relief pattern on the part;
(c) measuring along the x, y, and z axes a region of interest containing the area relief pattern;
(d) extracting the area relief pattern from the measured region of interest; and
(e) decoding the area relief pattern to extract part information encoded therein.

11. A method according to claim 10, wherein the step of measuring the region of interest comprises employing a laser line scanner adapted for projecting a laser line onto the surface of the part containing the area relief pattern.

12. A method according to claim 11, wherein the step of measuring the region of interest further comprises moving the coded part relative to the laser line scanner.

13. A method according to claim 12, and comprising measuring the region of interest on-the-fly as the coded part is moved past the laser line scanner.

14. A method according to claim 13, and comprising moving the coded part past the laser line scanner at a minimum rate of 1 fps.

15. A method according to claim 14, and comprising arranging multiple laser line scanners at predetermined locations relative to the moving coded part.

16. A method according to claim 10, wherein the area relief pattern comprises a peened area code.

17. A method according to claim 10, wherein the coded part comprises a cast alloy wheel.

18. A method according to claim 17, wherein the area relief pattern is formed with a rim barrel of the wheel.
